(19) United States
(12) Patent Application Publication
(10) Pub. No.: US 2009/0298372 A1
(43) Pub. Date: Dec. 3, 2009

(54) ARTICLE COMPRISING IONOMER AND POLYAMIDE

(75) Inventors: RICHARD T. CHOU, HOCKESSIN, DE (US); KARLHEINZ HAUSMANN, AUVERNIER (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/484,915

(22) Filed: Jun. 15, 2009

Related U.S. Application Data
(63) Continuation-in-part of application No. 10/861,973, filed on Jun. 4, 2004.
(60) Provisional application No. 60/475,978, filed on Jun. 5, 2003.

(51) Int. Cl. B32B 27/34; B32B 27/00; B32B 27/08

(52) U.S. Cl. 442/288; 428/423.5; 428/474.7; 428/475.2; 428/476.3; 428/476.9; 428/477.4; 428/479.3; 428/479.6; 428/474.9; 428/475.5; 428/476.1; 442/290; 442/291; 442/396; 442/398; 442/399

(57) ABSTRACT

A multilayer structure comprises a surface layer, a substrate, and optionally additional layers wherein the surface layer comprises or is produced from a blend comprising an ionomer and a polyamide; the ionomer is or must be derived from at least three repeat units derived from ethylene, an α,β-unsaturated C₃-C₈ carboxylic acid, and a dicarboxylic acid or its derivative; and the dicarboxylic acid or its derivative is maleic acid, fumaric acid, itaconic acid, maleic anhydride, fumaric anhydride, itaconic anhydride, maleic acid monoester, fumaric acid monoester, itaconic acid monoester, or combinations of two or more thereof.

This application is a continuation in part of application Ser. No. 10/861,973, filed Jun. 4, 2004, now pending, which claims priority to provisional application 60/475978, filed Jun. 5, 2003; the entire disclosures of the Ser. No. 10/861,973 and 60/475978 applications are incorporated by reference.

The invention relates to articles comprising a top or surface layer of a composition of ionomer and polyamide wherein the top is scuff- and/or scratch-resistant, transparent decorative, and protective.

### BACKGROUND OF THE INVENTION

Polymer films are being used more frequently for surface decoration and protection instead of coatings. For example, polymer film decorations increasingly provide freedom of design, lower cost and are environmentally more compatible than the conventional coating process. The surfaces of many sports and industrial articles are designed with protective and decorative films. Many applications demand new materials with excellent processability, mechanical properties, impact toughness, scratch resistance and excellent optical properties. Most importantly, the materials must be available at an affordable cost for broad applications.

Ionomers are thermoplastic resins that contain metal ions in addition to organic-chain molecules. Ionomers have solid-state properties characteristic of cross-linked polymers and melt-fabricability properties characteristic of uncrosslinked thermoplastic polymers (see for example U.S. Pat. No. 3,262,272). As disclosed in U.S. Pat. No. 3,262,272, it is not essential that only one type of metal ion be employed in the formation of the ionomers, and more than one type of metal ion may be preferred in certain applications. However, commercially available ionomers such as SURLYN® are neutralized with a single metal ion, commonly zinc or sodium. Major applications of ionomers are in the areas of packaging and for sporting goods, especially golf balls.

Owing to their water-like clarity and high toughness, ionomers such as those available from DuPont under the trademark SURLYN® have also been disclosed for use in protective and decorative applications, such as a top layer for floor tile (WO 95/11333 describes the use of ionomers as the topcoat layer of a multilayer flooring material). Scuff resistance can be defined as the resistance to the creation of a permanent surface mark through the frictional heating generated by a moving object sliding over the surface of the protective surface. Scuff resistance is a particularly desired property when used in protective and decorative applications. Typical ethylene copolymer ionomers as described above have a melting temperature below 100° C. and attempts to overcome this shortcoming find their natural barrier at 120° C., which is the melting temperature of low-density polyethylene. Because of their relatively low melting temperature, ethylene copolymer ionomers can be particularly vulnerable to scuffing. This may result in insufficient scuff resistance of ionomers in everyday use and greatly limits the use of ionomers in more demanding applications.

Previously, when problems of scratching or scuffing a surface or a film made of an ionomer film or sheet arose, these problems had to be overcome by crosslinking these ionomers by external crosslinking agents such as organic compounds or epoxy and formaldehyde functionalities. For example, U.S. Pat. No. 3,264,269, and U.S. Pat. No. 3,317,631 treat this problem and claim solutions to it. U.S. Pat. No. 3,264,269 teaches a process for crosslinking polymers containing carboxyl groups that comprises imbibing a shaped article of the polymer in a diisocyanate. The disadvantages of this process include its two-step nature (processing and imbibing) combined with the toxic nature of diisocyanates. U.S. Pat. No. 3,317,631 describes thermosetting compositions based on ethylene carboxylic acid copolymers and melamine formaldehyde resins giving essentially a thermoset polymer without possibility of thermoplastic processability.

Other solutions to this inherent problem attempt to increase the melting temperature through different synthesis conditions (U.S. Pat. No. 4,248,990). The shortcomings of this approach consist of increasing crystalline regions in the polymer that lead to reduced clarity while providing only a modest increase in melting temperature and therefore scuff resistance. Also, scratch resistance suffers significantly.

The manners of overcoming this problem described above are not free of shortcomings. Either they are limited in effectiveness by the inherent melting temperature of polyethylene or they add significant cost or feasibility problems to the processor and/or end user of the ionomer sheets and films used for protective applications.

Polyamides, particular nylon-6, are engineering polymers that can be used for many applications, but they cannot be used for decorative and protective film applications. To use polyamide for decorative and protective film applications, it has to be modified by improving toughness, reducing stiffness and enhancing optical transparency. Adding modifiers brings about a desirable toughness and stiffness tends to reduce the optical clarity and can turn polyamide into an opaque film. Mixing of polyamide and ionomer such as those described in U.S. Pat. No. 3,317,631 leads to blends with good scratch resistance and other surface properties but with very poor optical properties (i.e. opacity). Blends of this type typically consist of microscopic particles of one polymer dispersed in a continuous phase of the other polymer. Poorly dispersed and/or large particles tend to scatter rather than transmit light. As a result the polymer blends tend to be opaque.

A new family of ionomers has been disclosed in U.S. Pat. No. 5,700,890, wherein neutralized ethylene acid copolymers are prepared using dicarboxylic acids, or derivatives thereof, as monomers in addition to the monocarboxylic acids used in typical ionomers. These ionomers have been found to have better compatibility with polyamides than typical ionomers (see U.S. Pat. No. 5,859,137). These ionomeric copolymers may further contain an alkyl acrylate comonomer. The excellent compatibility of these ethylene copolymer ionomers with polyamides allows the formation of alloys with higher crystalline melting temperatures.

### SUMMARY OF THE INVENTION

A multilayer structure comprises a surface or top layer, a substrate, and optionally additional layers wherein

the surface layer and the substrate is preferably a coextruded;

the surface layer is a film or sheet;

the film or sheet comprises or is produced from a blend of or comprising an ionomer and a polyamide;

the ionomer is or must be derived from at least three repeat units derived from ethylene, an α,β-unsaturated C₃-C₈ carboxylic acid, and a dicarboxylic acid or its derivative;

the dicarboxylic acid or its derivative is maleic acid, fumaric acid, itaconic acid, maleic anhydride, fumaric anhydride, itaconic anhydride, maleic acid monoester, fumaric acid monoester, itaconic acid monoester, or combinations of two or more thereof;

the acid moiety or a portion thereof in the ionomer is neutralized with one or more metal ions;

the polyamide is derived from one or more lactams or amino acids and is not a polycondensation product of diacids and diamines; and

the substrate can be a film or sheet comprising or derived from polyvinyl chloride, ethylene vinyl acetate copolymer, ethylene propylene diene (EPDM) elastomer, polypropylene, ethylene copolymer, cellulosic material, wood fiber, ionomer, polyamide, polyester, polyurethane, styrenic polymer, acrylonitrile-butadiene-styrene copolymer, or combinations of two or more thereof.

### DETAILED DESCRIPTION OF THE INVENTION

All references disclosed herein are incorporated by reference.

“Copolymer” means polymers containing two or more different monomers. The terms “dipolymer” and “terpolymer” mean polymers containing only two and three different monomers respectively. The phrase “copolymer of various monomers” means a copolymer whose units are derived from the various monomers.

Thermoplastic resins are polymeric materials that can flow when heated under pressure. Melt index (MI) is the mass rate of flow of a polymer through a specified capillary under controlled conditions of temperature and pressure and is measured according to ASTM 1238.

A surface layer of a multilayer structure refers to the layer that has one of its surfaces not in contact with the substrate layer disclosed herein.

The film or sheet of the surface or top layer can have a thickness of about 5 to about 600, about 10 to about 500, about 10 to about 400, about 15 to about 300, 20 to 250, 50 to 250, or 100 to 200, mμ, unless otherwise disclosed below for certain application.

The polyamide can be present in the surface layer, based on the weight of the surface layer, from about 30 to about 65 weight % and the ionomer can be present from about 70 to about 35 weight %.

The ionomer can be derived from ethylene, about 5 weight % to about 15 weight % of an α,β-unsaturated C₃-C₈ carboxylic acid, and 0.5 weight % to 12 weight % of dicarboxylic acid that is an α,β-ethylenically unsaturated dicarboxylic acid or derivative thereof. The dicarboxylic acid can be selected from the group consisting of maleic acid, fumaric acid, itaconic acid, maleic anhydride, fumaric anhydride, itaconic anhydride, maleic acid monoester, fumaric acid monoester, itaconic acid monoester, or combinations of two or more thereof. The monoester can be derived from the dicarboxylic acid and a C₁₋₄ alcohol.

The ethylenically unsaturated dicarboxylic acid comonomers such as maleic anhydride and ethyl hydrogen maleate, at least partially neutralized by one or more alkali metal, transition metal, or alkaline earth metal cations (anhydride SURLYN®). They are copolymers of ethylene, an α,β-unsaturated C₃-C₈ carboxylic acid and at least one comonomer that is an ethylenically unsaturated dicarboxylic acid at an amount of from about 3 weight % to about 25 weight %. Preferably, the dicarboxylic acid comonomer(s) are present in an amount from about 4 weight % to about 10 weight %. The unsaturated dicarboxylic acid comonomers are, for example, maleic anhydride (MAH), ethyl hydrogen maleate (also known as maleic acid monoethyl ester—MAME), itaconic acid, etc.

The ionomer can optionally contain 0 weight % to about 30 weight % of monomers selected from alkyl acrylate and alkyl methacrylate, wherein the alkyl groups have from one to twelve carbon atoms and the carboxylic acid functionalities moieties present are at least partially neutralized by one or more alkali metal, transition metal, or alkaline earth metal cations.

At least one alkali metal, transition metal, or alkaline earth metal cation, such as lithium, sodium, potassium, magnesium, calcium, or zinc, or a combination of such cations, is used to neutralize some portion of the acidic groups in the copolymer resulting in a thermoplastic resin exhibiting enhanced properties. For example, a copolymer of ethylene and acrylic acid can then be at least partially neutralized by one or more alkali metal, transition metal, or alkaline earth metal cations to form an ionomer. Copolymers can also be made from an olefin such as ethylene, an unsaturated carboxylic acid and other comonomers such as alkyl (meth)acrylates providing “softer” resins that can be neutralized to form softer ionomers.

Comonomers such as alkyl (meth)acrylates can be included in the ethylene acid copolymer to form a copolymer of various monomers that can be neutralized with alkali metal, alkaline earth metal or transition metal cations. Comonomers can be alkyl acrylate and alkyl methacrylate wherein the alkyl groups have from 1 to 8 carbon atoms such as methyl acrylate, ethyl acrylate and n-butyl acrylate. The alkyl (meth)acrylates are included in amounts from 0 to about 30 weight % alkyl (meth)acrylate and preferably from 0 to about 15 weight %.

Examples of copolymers useful in this invention include copolymers of ethylene, methacrylic acid and ethyl hydrogen maleate (E/MAA/MAME) and copolymers of ethylene, acrylic acid and maleic anhydride (E/AA/MAH).

Neutralization of an ethylene acid copolymer can be effected by first making the ethylene acid copolymer and treating the copolymer with inorganic base(s) with alkali metal, alkaline earth metal or transition metal cation(s). The copolymer can be from about 10 to about 99.5% neutralized with at least one metal ion selected from lithium, sodium, potassium, magnesium, calcium, barium, lead, tin, zinc, aluminum; or combinations of such cations. Neutralization is about 10 to about 70%. The copolymer can have from about 35 to about 70% of the available carboxylic acid groups ionized by neutralization with at least one metal ion selected from sodium, zinc, lithium, magnesium, and calcium; and more preferably zinc or magnesium. Zinc or a combination of zinc and magnesium ions is commonly used. Methods for preparing ionomers from copolymers are well known in the art.

Polyamides are prepared from lactams or amino acids (e.g. nylon-6 or nylon-11) and are not prepared from condensation of diamines such as hexamethylene diamine with dibasic acids such as succinic, adipic, or sebacic acid. Copolymers and terpolymers of these polyamides are also included. Preferred polyamides useful in the present invention include polyepsiloncaprolactam (nylon-6); polyhexamethylene adipamide (nylon-6,6); nylon-11; nylon-12, or combinations of two or more thereof.

The surface layer can comprise additional thermoplastic materials blended with polyamide component (1) and ionomeric copolymer component (2). Blending additional components allows one to more easily modify the properties of the surface layer by manipulating the amount and type of additional components present in the surface layer in addition to varying the percentages of the monomers in the ethylene acid copolymer. Furthermore, blending additional thermoplastic materials can allow for easier, lower cost manufacture of polymer compositions by allowing one to prepare fewer base resins that can be subsequently modified to obtain desired properties. Examples of other thermoplastic materials that can be used in addition to the components (1) and (2) include nonionomeric thermoplastic copolymers and/or ionomeric thermoplastic copolymers. The additional nonionic thermoplastic polymer components can be selected from among copolyetheresters, copolyetheramides, elastomeric polyolefins, styrene diene block copolymers, thermoplastic polyurethanes, etc., these classes of polymers being well known in the art (see below for more detailed descriptions of these materials).

Examples are blends of component (1) and component (2) further comprising conventional ionomers (i.e. ionomers that do not comprise a dicarboxylic acid comonomer). Accordingly, surface layer includes blends of component (1) and component (2), as previously defined, further comprising (3) one or more E/X/Y copolymers where E is ethylene, X is a C₃ to C₈ α,β ethylenically unsaturated carboxylic acid, and Y is a comonomer selected from alkyl acrylate and alkyl methacrylate wherein the alkyl groups have from 1 to 8 carbon atoms, wherein X is present in from about 2 to about 30 weight % of the E/X/Y copolymer, Y is present from 0 to about 40 weight % of the E/X/Y copolymer, at least partially neutralized by one or more alkali metal, transition metal, or alkaline earth metal cations. Illustrative examples of conventional ionomers include E/15MAA/Na, E/19MAA/Na, E/15AA/Na, E/19AA/Na, E/15MAA/Mg and E/19MAA/Li (wherein E represents ethylene, MAA represents methacrylic acid, AA represents acrylic acid, the number represents the weight % of monocarboxylic acid present in the copolymer and the atomic symbol represents the neutralizing cation). When such conventional ionomer or combination of conventional ionomers are added to the blend of polyamide and ionomeric copolymer containing the dicarboxylic acid comonomer, the conventional ionomers can be a substitute for up to half (50% by weight) of component 2.

The surface layer can additionally comprise optional materials, such as conventional additives used in polymeric materials including: plasticizers, stabilizers, antioxidants, ultraviolet ray absorbers, hydrolytic stabilizers, anti-static agents, dyes or pigments, fillers, fire-retardants, lubricants, reinforcing agents such as glass fiber and flakes, processing aids, antiblock agents, release agents, and/or mixtures thereof.

The substrate can be a film or sheet comprising or derived from polyvinyl chloride, ethylene vinyl acetate copolymer, ethylene propylene diene (EPDM) elastomer, polypropylene, ethylene copolymer, cellulosic material, wood fiber, ionomer, polyamide, polyester, polyurethane, styrenic polymer, or combinations of two or more thereof. The substrate can have the same thickness of, or thicker than, the surface layer.

Ethylene copolymer can include ethylene (meth)acrylic acid copolymer (e.g., ethylene acrylic acid copolymer or ethylene methacrylic acid copolymer), ethylene alkyl (meth)acrylate copolymer (e.g., ethylene acrylate copolymer, ethylene methacrylate copolymer, ethylene methyl acrylate copolymer, ethylene methyl (meth)acrylate copolymer, ethylene ethyl acrylate copolymer, ethylene butyl acrylate copolymer, ethylene butyl acrylate methyl acrylate copolymer, ethylene butyl acrylate methacrylate copolymer, ethylene glycidyl methacrylate copolymer, ethylene butyl acrylate glycidyl methacrylate copolymer, or combinations of two or more thereof), or combination of two or more thereof.

Cellulosic material can be obtained from wood and wood products (e.g., wood, wood pulp fibers); non-woody paper-making fibers from cotton; straws and grasses (e.g., rice or esparto); canes and reeds (e.g., bagasse); bamboos; stalks with bast fibers (e.g., jute, flax, kenaf, cannabis, linen, or ramie); leaf fibers (e.g. abaca and sisal); paper (including recycled paper) or polymer-coated paper. The cellulosic material commonly used is from a wood source including softwood sources such as pines, spruces, and firs, and hardwood sources such as oaks, maples, eucalyptuses, poplars, beeches, and aspens. The form of the cellulosic materials from wood sources may be sawdust, wood chips, wood flour, or combinations of two or more thereof.

The wood fiber or flour can be obtained from soft wood, hard wood, or both such as oak or pine available American Wood Fibers of Schofield, Wis. Maple wood flour may also be used.

Polyamide can include those disclosed above and those made by condensation of diacid (or anhydride or other derivative) and diamine (e.g., nylon 6,6, nylon 6,10, nylon 6, 12, nylon 6I, nylon 6T, or nanocomposites of one or more of these nylons, or combinations of two or more thereof).

Polyester includes polyethylene terephthalate, polypropylene terephthalate, polybutylene terephthalate, or combinations of two or more thereof.

Styrenic polymers include of polystyrene units and polydiene units. The polydiene units are derived from polybutadiene, polyisoprene units or copolymers of these two. These materials are usually referred to as SBS, SIS or SEBS thermoplastic elastomers and they can also be functionalized with maleic anhydride.

These polymers are well known to one skilled in the art, the description of which is therefore omitted herein for the interest of brevity.

The substrate layer can also comprise optional materials, such as conventional additives used in polymeric materials including: plasticizers, stabilizers, antioxidants, ultraviolet ray absorbers, hydrolytic stabilizers, anti-static agents, dyes or pigments, fillers, fire-retardants, lubricants, reinforcing agents such as glass fiber and flakes, processing aids, antiblock agents, release agents, and/or mixtures thereof. For example, the surface layer can be filled with up to 60% by weight of the substrate of filler such as glass, talc, calcium carbonate, any other known filler, or combinations of two or more thereof.

If the substrate comprises two or more incompatible polymers, a compatibilizer (sometimes also referred to as coupling agent) can be used. This compatibilizer may be present in an amount of from about 0.1 to about 10, about 0.1 to about 5, or about 1 to about 4, weight % based on the total weight of the composition. A well known compatibilizer is a maleic anhydride-grafted polyolefin commercially available from DuPont under the trademark of Fusabond® including maleated polyethylene and maleated polypropylene.

The substrate can also be attached, laminated, or adhered to one or more layers of any polymer or non-polymer materials disclosed above. For convenience, the additional layer(s) is referred to as bottom layer.

The surface layer can be clear and transparent such that a printable film layer can be included between the surface layer and the substrate. In many cases the print can be applied either to the surface layer (i.e., reverse printing) or to the substrate layer or to an intermediate layer, which can be a polymer film, that is inserted in between the filled bottom layer and the surface layer.

The multilayer structure can be formed into articles by various means known to those skilled in the art. For example, the composition of the surface layer can be molded or extruded to provide an article that is in a desired shape. The compositions of this invention can be cut, injection molded, overmolded, laminated, extruded, milled or the like to provide a desired shape and size. Optionally, articles comprising the conductive thermoplastic composition of this invention may be further processed. For example, portions of the composition (such as, but not limited to, pellets, slugs, rods, ropes, sheets and molded or extruded articles) may be subjected to thermoforming operations in which the composition is subjected to heat, pressure and/or other mechanical forces to produce shaped articles. Compression molding is an example of further processing.

The multilayer structure can include other polymer layers formed independently and then adhesively attached to one another; fabricated by extrusion coating or laminating some or all of the layers onto the substrate. Examples of articles include an article comprising the surface layer transformed into a transparent protective scratch-resistant film or sheet on a scratch-exposed object; an article comprising the surface layer that is a sheet used as a transparent scratch-resistant layer on auto interior or exterior applications; an article comprising a composition of this invention that is a sheet used as a transparent scratch-resistant layer for flooring tiles or sheets; an article comprising a composition of this invention that is a sheet used as a transparent scratch-resistant layer for a sporting good; and an article comprising a composition of this invention that is a film used as packaging film for dry abrasive goods.

Some of the components of an article may be formed together by coextrusion, particularly if the components are relatively coplanar. For example, additional layers of thermoplastic resins may be included to provide structure layers to which the surface layer is adhered to provide protection or improve the appearance of the article. This multilayer structure could be further processed by thermoforming the sheet into a shaped article. For example, a sheet of the multilayer structure could be formed into a casing element for a portable communication device or it could be formed into a shaped piece that could be included in an automotive part such as a bumper, fender or panel.

Examples of other thermoplastic materials that can be used to form a component of an article can be selected from nonionomeric thermoplastic copolymers and/or ionomeric thermoplastic copolymers. The additional thermoplastic polymer components can be selected from among copolyetheresters, copolyetheramides, elastomeric polyolefins, styrene diene block copolymers, thermoplastic polyurethanes, etc., these classes of polymers being well known in the art.

Nonionic thermoplastic resins include, by way of non-limiting illustrative examples, thermoplastic elastomers, such as polyurethane, poly-ether-ester, poly-amide-ether, polyether-urea, PEBAX (a family of block copolymers based on polyether-block-amide, commercially supplied by Atochem), styrene-butadiene-styrene (SBS) block copolymers, styrene(ethylene-butylene)-styrene block copolymers, etc., polyamide (oligomeric and polymeric), polyesters, polyolefins including polyethylene, polypropylene, ethylene/propylene copolymers, etc., ethylene copolymers with various comonomers, such as vinyl acetate, (meth)acrylates, (meth)acrylic acid, epoxy-functionalized monomer, CO, etc., functionalized polymers with maleic anhydride, epoxidization etc., either by copolymerization or by grafting, elastomers such as EPDM, metallocene catalyzed PE and copolymer, ground up powders of the thermoset elastomers, etc.

Non-limiting, illustrative examples of conventional ionomers include E/15MAA/Na, E/19MAA/Na, E/15AA/Na, E/19AA/Na, E/15MAA/Mg and E/19MAA/Li (wherein E represents ethylene, MAA represents methacrylic acid, AA represents acrylic acid, the number represents the weight % of monocarboxylic acid present in the copolymer and the atomic symbol represents the neutralizing cation).

Copolyetheresters are discussed in detail in patents such as U.S. Pat. Nos. 3,651,014; 3,766,146; and 3,763,109. Preferred copolyetherester polymers are those where the polyether segment is obtained by polymerization of tetrahydrofuran and the polyester segment is obtained by polymerization of tetramethylene glycol and phthalic acid. The more polyether units that are incorporated into the copolyetherester, the softer the polymer.

The copolyetheramides are also well known in the art as described in U.S. Pat. No. 4,331,786, for example. They are comprised of a linear and regular chain of rigid polyamide segments and flexible polyether segments.

A laminate film of the present invention can be prepared by coextrusion as follows: granulates of the various components are melted in extruders. The molten polymers are passed through a die or set of dies to form layers of molten polymers that are processed as a laminar flow. The molten polymers are cooled to form a layered structure. Molten extruded polymers can be converted into a film using a suitable converting technique. For example, a film of the present invention can also be made by coextrusion followed by lamination onto one or more other layers. Other suitable converting techniques are, for example, blown film extrusion, cast film extrusion, cast sheet extrusion and extrusion coating.

The multilayer structure can be further oriented beyond the immediate quenching or casting of the film. The process comprises the steps of (co)extruding a laminar flow of molten polymers, quenching the (co)extrudate and orienting the quenched (co)extrudate in at least one direction. The film may be uniaxially oriented, or it can be biaxially oriented by drawing in two mutually perpendicular directions in the plane of the film to achieve a satisfactory combination of mechanical and physical properties.

Orientation and stretching apparatus to uniaxially or biaxially stretch film are known in the art and may be adapted by those skilled in the art to produce films of the present invention. Examples of such apparatus and processes include, for example, those disclosed in U.S. Pat. Nos. 3,786,63; 3,337,665; 3,456,044; 4,590,106; 4,760,116; 4,769,421; 4,797,235 or 4,886,634.

The surface layer or substrate or both may be oriented using a double bubble extrusion process, where simultaneous biaxial orientation may be effected by extruding a primary tube which is subsequently quenched, reheated and then expanded by internal gas pressure to induce transverse orientation, and drawn by differential speed nip or conveying rollers at a rate which may induce longitudinal orientation. The processing to obtain an oriented blown film is known in the art as a double bubble technique, and can be carried out as disclosed in U.S. Pat. No. 3,456,044.

The multilayer structure also may be laminated or adhered to, or by injection molding or compression molding with, additional substrate(s) including, e.g., nonwoven material, woven material, or nonpolymer material such as glass, wood, or metal foil or shaped substrates.

The multilayer structure can be adhered to a shaped article to provide a protective layer. For example, multilayer structure can be thermoformed by heat and/or pressure to adhere to a substrate to form an automotive part or a sporting good. Examples of articles that comprise the multilayer structure disclosed above can include flooring, furniture films, ski top layers, auto interior top layers, auto exterior scratch resistant top layers, or coverings for steps in stair cases.

Usually the bottom layer of a floor covering can be polyvinyl chloride, ethylene vinyl acetate copolymer, ethylene methyl acrylate copolymer, ethylene butyl acrylate copolymer, or EPDM which can be highly filled (30-95%) with fillers such as clay, CaCo₃, or talc. In between the surface layer and the bottom layer, it may include a polyester or polypropylene nonwoven layer. Glass fibers can be used between the filled bottom layer and the surface layer. The surface layer can be clear and transparent such that a printable film layer can be included between the surface layer and the substrate. In many cases the print can be applied either to the surface layer (i.e., reverse printing) or to the bottom layer or to an intermediate layer (can be a polymer film) that is inserted in between the filled bottom layer and the surface layer. In that case the adhesive layer may be inserted.

In wood flooring (e.g., parketts), the bottom layer is a natural material (wood or cork) which can be printed with some kind of color. It may be desirable to insert an adhesive layer between wood and the surface layer that can adhere to this color. Any known adhesive can be used.

The surface cover for the wood flooring where the substrate is wood or wood fiber or wood flour can include a maleic acid-grated ethylene copolymer such as ethylene vinyl acetate, a regular SURLYN® (i.e., ionomer without the dicarboxylic acid comonomer), or ethylene methyl acrylate. The thickness of surface layer can be 100-200 mμ and the thickness of the entire multilayer structure can be 300-600 mμ.

In furniture, the substrate can be MDF (compression molded wood such as that using polyvinyl chloride), compressed wood, or polypropylene film or sheet coated with polyurethane. The thickness of such multilayer structure may be 200 mμ.

When used as sKi top layer, the multilayer structure can be up to 1000 mμ thick. The surface layer may be coextruded with ski substrate, which can be anything from wood to ABS.

In application for auto Interior part top layers, the multilayer structure can be adhered to polypropylene or metal substrate.

As to auto exterior scratch resistant top layers, the substrate can be an ionomer that is clear or pigmented and the surface layer is clear to provide scratch- or scuff-resistance.

The multilayer structure can also be used as coverings for steps in stair cases where the surface layer can be adhered, using for example, a pressure sensitive adhesive, to the substrate, which is the stir case, wood, metal, rock, or stone.

The multilayer structure may also be used for other wear- and scratch-exposed objects such as seal layers in packaging structures that contain hard, abrasive objects such as dry soup mixes. Here, the surface or to layer can be heat sealed to another substrate or another film or sheet structure. Such another substrate can be metal surface, metal, metal foil, paperboard, stone, leather, or any of the substrates disclosed above.

### EXAMPLES

The following Examples are merely illustrative, and are not to be construed as limiting the scope of the invention described and/or claimed herein.

Examples of thermoplastic compositions for producing a film or sheet or molded articles of scuff- and scratch-resistant transparent material of this invention comprise neutralized ethylene acid copolymers with monocarboxylic and dicarboxylic acids as monomers blended with polyamides. See Table 1 below for specific examples. Table 1 reports the properties of blends of a polyamide (i.e. nylon-6) and neutralized ethylene acid copolymers with monocarboxylic and dicarboxylic acids as monomers (i.e. anhydride SURLYN®). The blends were prepared by melt mixing the base resins in a 30-mm twin-screw extruder. The polymers used in Table 1 are:

Nylon-6: Ultramid B3 (from BASF)

Anhydride SURLYN® A: a terpolymer comprising ethylene, 11 weight % of methacrylic acid and 6 weight % of maleic anhydride monoethyl ester wherein nominally 40% of the available carboxylic acid moieties are neutralized with zinc cations (E/11MAA/6MAME/40Zn), having a melt temperature of 98° C.

Anhydride SURLYN® B: a terpolymer comprising ethylene, 11 weight % of methacrylic acid and 6 weight % of maleic anhydride monoethyl ester wherein nominally 60% of the available carboxylic acid moieties are neutralized with zinc cations (E/11MAA/6MAME/60Zn).

The resulting blends were extruded to form either injection-molded plaques or films as described further below.

The Izod impact was measured by using ASTM D-256 with an injection-molded specimen. The tensile strength was measured using ASTM D-638 with press-molded films about 10-15 mil thick. The transmittance haze was measured according to ASTM D1003 by using press-molded films about 10-15 mil thick.

Sheet of the blends can be prepared on a laboratory 2-roll mill and pressing the so-obtained sheet in a hydraulic press into plaques of the dimensions 100 mm×100 mm×3 mm. These plaques were then tested immediately and after one month for scratch resistance using a scratch tester by Eirichsen according to ISO1518 where a mass between 0.1 and 2 kg is applied to a needle that is drawn over the surface of the plaque. This apparatus measures the force in Newtons at which a scratch mark is visible on the surface.

A scuff test was also performed. This type of test is not standardized; different versions are used by those skilled in the art of scuff testing. Usually the severity of a scuff mark is related to the ease of melting of the polymer under the influence of frictional heat. Scuff tests typically consist of subjecting the sample surface to the high-speed friction of a moving object. In this case, the moving object was the Taber abrader wheel CSO according to ASTM D3389. The wheel was moved over the sample surface using a pendulum with a pendulum radius of 86 cm and a mass of 2.96 kg. The Taber abrader wheel is fixed in a way that the axis of the wheel creates an angle of 45 degrees to the scuffed surface. Furthermore the scuffed or to be scuffed surface of the sample is positioned at an angel of 5 degrees to the floor/ground surface in order to decelerate the movement of the pendulum. The resulting scuff marks were judged on a scale of 1 to 5; 1 being minor and 5 being severe. For purposes of this scuff measurement a commercial grade SURLYN® (E/15% MAA-Zn) was assigned the rating “5” (i.e., failed) and a comparative rating of between 2 and 3 or lower was considered passing.

Comparative Examples C-1 and C-2 (i.e. blends of nylon-6 with low amounts of anhydride SURLYN®) exhibit low impact strength and poor optical properties (as indicated by the haze values reported in Table 1). In contrast, the data in Table 1 clearly demonstrate that the blends prepared according to this invention (i.e. nylon-6 with high amounts of anhydride SURLYN®) have high toughness, good mechanical strength, excellent scuff and scratch resistance and have good optical properties. All of these properties are needed for decorative and protective film applications.

TABLE 1

| | Anhydride | | | Notched Izod Impact | | Tensile Properties (Kpsi, except | | |
|---|---|---|---|---|---|---|---|---|
| | SURLYN ® | Haze | Scuff | (ft-lbs) | | elongation, which is %) | | |
| | (Wt %) | (%) | Test | Room temp | 0° C. | Tensile strength | Elongation | Modulus |
| C-1 | A (20) | 68 | N/A | 2.4 | 1.7 | 6.2 | 280 | 115 |
| C-2 | A (30) | 65 | N/A | 3.6 | 2.3 | 4.9 | 150 | 105 |
| 1 | A (40) | 20 | passed | 25.8 | 21 | 4.3 | 300 | 80 |
| 2 | A (45) | 8.8 | passed | 23 | 25 | 4.2 | 250 | 65 |
| 3 | A (50) | 7.2 | passed | 22.2 | 26 | 3.6 | 250 | 57 |
| 4 | A (55) | 6.5 | passed | 21 | 25 | 3.4 | 260 | 48 |
| 5 | A (60) | 6.0 | passed | 21 | 24 | 3.8 | 340 | 45 |
| 6 | B (45) | 30 | N/A | 27 | 27 | 5.8 | 380 | 80 |

N/A denotes not analyzed.

1. A multilayer structure comprising a surface or top layer, a substrate, and optionally one or more additional substrates wherein
the surface layer is a film or sheet;
the film or sheet comprises or is produced from a blend comprising an ionomer and a polyamide;
the ionomer is derived from at least three repeat units derived from ethylene, an α,β-unsaturated C₃-C₈ carboxylic acid, and a dicarboxylic acid or its derivative;
the dicarboxylic acid or its derivative is maleic acid, fumaric acid, itaconic acid, maleic anhydride, fumaric anhydride, itaconic anhydride, maleic acid monoester, fumaric acid monoester, itaconic acid monoester, or combinations of two or more thereof;
the acid moiety or a portion thereof in the ionomer is neutralized with one or more metal ions;
the polyamide is derived from one or more lactams or amino acids; and
the substrate is a film or sheet comprising or derived from polyvinyl chloride, ethylene vinyl acetate copolymer, ethylene propylene diene elastomer, polypropylene, ethylene copolymer, cellulosic material, wood fiber, ionomer, polyamide, polyester, polyurethane, styrenic polymer, acrylonitrile-butadiene-styrene copolymer, or combinations of two or more thereof.

2. The multilayer structure of claim 1 wherein the polyamide is nylon 6, nylon 11, or nylon 12.

3. The multilayer structure of claim 1 wherein the dicarboxylic acid or its derivative is maleic acid, maleic anhydride, maleic acid monoester, or combinations of two or more thereof;

4. The multilayer structure of claim 3 wherein the dicarboxylic acid or its derivative is a C₁-C₄ alkyl half ester of maleic acid.

5. The multilayer structure of claim 2 wherein the dicarboxylic acid or its derivative is maleic acid, maleic anhydride, maleic acid monoester, or combinations of two or more thereof;

6. The multilayer structure of claim 4 wherein the dicarboxylic acid or its derivative is a C₁-C₄ alkyl half ester of maleic acid.

7. The multilayer structure of claim 6 wherein the surface layer is coextruded with the substrate.

8. The multilayer structure of claim 6 wherein the multilayer structure further comprises the additional substrate and the additional substrate is polymer film or sheet, woven material, nonwoven material, or a shaped article.

9. The multilayer structure of claim 6 further comprising one or more layers in contact with the surface layer.

10. The multilayer structure of claim 8 wherein one or more layers of the multilayer structure contain pigment, dye, flake, or combinations of two or more thereof.

11. The multilayer structure of claim 10 wherein the surface layer is clear and the substrate contains pigment, dye, flake, or combinations of two or more thereof.

12. The multilayer structure of claim 9 wherein the multilayer structure is a packaging material.

13. An article comprising a multilayer structure wherein
the article includes floor covering, furniture film covering, ski top, sporting good, auto interior top layer, auto exterior scratch resistant top layer, or covering for steps in stair cases; and
the multilayer structure is as recited in claim 1.

14. The article of claim 13 wherein the article is the floor covering and the dicarboxylic acid or its derivative is maleic acid, maleic anhydride, maleic acid monoester, or combinations of two or more thereof.

15. The article of claim 14 wherein
the polyamide is nylon 6, nylon 11, or nylon 12.
the dicarboxylic acid or its derivative is a C₁-C₄ alkyl half ester of maleic acid;
the multilayer structure further comprises one or more layers in contact with the substrate; and
one or more layers of the multilayer structure contain pigment, dye, flake, or combinations of two or more thereof.

16. The article of claim 13 wherein the article is the furniture film covering.

17. The article of claim 13 wherein the article is the sporting good.

18. The article of claim 13 wherein the article is the ski top, auto interior top layer, auto exterior scratch resistant top layer, or covering for steps in stair cases.

19. The article of claim 13 wherein the article is the auto interior top layer or auto exterior scratch resistant top layer.

20. The article of claim 13 wherein the article is the covering for steps in stair cases.
